(19) United States
(12) Patent Application Publication
(10) Pub. No.: US 2012/0285028 A1
(43) Pub. Date: Nov. 15, 2012

(54) TOOL SYSTEM FOR LAYOUT OF A PITCH

(76) Inventor: RAYMOND E. ATWOOD, LOS GATOS, CA (US)

(21) Appl. No.: 13/468,136

(22) Filed: May 10, 2012

Related U.S. Application Data
(60) Provisional application No. 61/484,283, filed on May 10, 2011.

(51) Int. Cl. B43L 7/10

(52) U.S. Cl. 33/452

(57) ABSTRACT

An apparatus and method for a tool to mark a pitch or a cut line for treads and risers of a stairway, is disclosed herein. The tool includes a first member for marking a rise dimension; a second member for marking a run dimension, and a guide member for acting as a guide against a work piece, all coupled together using adjustable fasteners. The rise dimension and the run dimension are perpendicular to each other, thereby creating a pitch for stair cutouts on a stringer work piece or a pitch for a rafter rake. Individually, the first and second member are selectively adjustable with respect to the guide member to provide a wide range of rise and run dimensions, respectively, The first, second, and guide members can be loosened and repositioned to compactly stow as a composite shape for easy storage and transport.

### REFERENCE TO RELATED APPLICATIONS

This application claims priority to U.S. provisional application Ser. No. 61/484,283 filed May 10, 2011, entitled “TOOL SYSTEM FOR LAYOUT OF A PITCH” which application is also incorporated by its reference herein, in its entirety.

### FIELD OF THE INVENTION

The present disclosure relates generally to a measuring device and more particularly to a multi-purpose measuring and marking device for layout of a pitch.

### DESCRIPTION OF THE RELATED ART

Stairs for typical residential homes and some businesses are built from wood, using two side pieces called stringers. Notches are cut into the stringers to provide for the flat part of the steps called a tread, and the vertical portion of the stair called a riser. The ratio of the rise over the run is referred to as the slope, rake, or pitch, of the stair. Government building codes typically provide strict regulation regarding the acceptable rise and run of the tread and riser, to provide an acceptable standard and a safe construction and design. Stairs are spaced out given over the height which they cover between landings, or floors, of a structure, e.g., from the first floor to a second floor landing. However, given the wide range of designs of homes and layout of stairs, there is a considerable variation in the number of different combinations of rise and run measurements used in the home-building and remodeling industry.

Measuring and marking the cut lines on the stringers for each set of tread and riser can be burdensome, confusing, and error-prone. It is desirable to have each stair nearly identical to each other, so when someone climbs the stairs, repeated locations of each tread is predictable and thus prevent stumbles and tripping, especially at night. Furthermore, the calculations of the first and last riser of the stairway must account for variations in floors, including subfloor and coverings.

### SUMMARY OF THE INVENTION

The present disclosure of the invention provides a method, apparatus, and system with several embodiments that overcome the limitations of, provide improvements to, and/or satisfy the needs of: measuring, and of marking a pitch or a cut line for treads and risers of a stairway, creating different rise and run measurements, having multiple systems of measure (standard and metric), and compactly storing its components for easy storage and transport.

A first embodiment of the present disclosure provides an apparatus that is a tool, or marking device, for marking or measuring, wherein the tool comprises a first member for marking a rise dimension; a second member for marking a run dimension, and a guide member for acting as a guide, or fence, (together, parts) against a work piece, wherein the guide member is coupled to the first member and second member using adjustable fasteners. The rise dimension and the run dimension are perpendicular to each other, thereby creating a pitch for stair cutouts on a stringer work piece. Individually, the first and second member are selectively adjustable in rise and/or run, while remaining square or 90° with respect to the guide member to provide a range of rise and run dimensions, respectively, to provide a wide range of pitches to match the needs of different stair patterns. Alternatively, the tool can be used to mark a cutout of any part needing a desired angle, or pitch, such as a rake cut on a rafter work piece to support a roof.

The first and second member and the guide member form a triangle when the tool is in its open position for stability and the marking function, with the angle between the first and second member being a right triangle, locked in by detents, stops, and or an adjustable fastener. Slots located in the first and second members and the guide member allow these members to slide and thereby adjust the rise dimension and the run dimension, respectively, against the guide member. The first and second members have markings on either one edge or on both edges, e.g., with different scales or units of measurement, for selectively marking a longer or shorter rise and run dimension for a same pitch. The marking device can be collapsed to form a compact closed shape by swinging the first and second members to out, to fold out, and thereby lay parallely, or stacked, on top of the guide member.

These and other advantages of the present disclosure will become apparent to those of ordinary skill in the art after having read the following detailed description of the preferred embodiments, which are also illustrated in the various drawing figures.

### BRIEF DESCRIPTION OF THE DRAWINGS

The drawings included herewith are incorporated in and form a part of this specification. The drawings illustrate one embodiment of the present disclosure and, together with the description, serve to explain the principles of the invention. It should be understood that drawings referred to in this description are not drawn to scale unless specifically noted.

FIG. 1 is a functional block diagram of a measuring system, according to one or more embodiments.

FIG. 2A is an isometric view of a tool in an open position against a wooden stringer, for measuring or marking a rise and run dimension for stairs, according to one or more embodiments.

FIGS. 2B and 2C are a top and side view, respectively, of a tool in an open position for measuring and marking a rise and run dimension, according to one or more embodiments.

FIG. 2D is a top view of an alternative retainer for adjustably coupling a first member used for measuring rise, against a guide member of a tool, according to one or more embodiments.

FIG. 2E is a top view of an alternative end piece of a first member and second member of a tool that creates a right triangle intersection for the rise and run dimension, respectively, according to one or more embodiments.

FIGS. 2F and 2G are top views of a tool, changing from a partially-closed to a fully-closed folded position for storage and transport, according to one or more embodiments.

FIG. 2H is a top view of a tool with first member, second member, and guide member swung into a position that creates a longest overall distance of the assembly, for purposes of providing a linear measuring tool, according to one or more embodiments.

FIGS. 2I and 2J are top views of a tool, changing from a partially-closed position to a fully elongated and stowed position for storage and transport, according to one or more embodiments.

FIG. 2K is a top view of a tool repositioned to on an opposite side of a guide member, in order to expose a different edge of a first and second member having different units of measure than the opposing edge, according to one or more embodiments.

FIG. 2L is a top view of a first member portion of the tool, with detents in the slot to provide positioning for traditional rise and run measurements, according to one or more embodiments.

FIG. 2M is a top view of a first member portion of the tool, with square or tapered countersinks on member at locations corresponding to traditional rise and run measurements, in accordance with one or more embodiments.

FIG. 2N is a top exploded view of an alternative end piece of a first member and second member of a tool that creates a right triangle intersection for the rise and run dimension, respectively, according to one or more embodiments.

FIG. 3 is a flowchart of a method for measuring or marking a rise or run on a work piece using a tool, according to one or more embodiments.

Other features of the present embodiments will be apparent from the accompanying drawings and from the detailed description that follows.

### DETAILED DESCRIPTION OF THE INVENTION

Reference will now be made in detail to the preferred embodiments of the invention. Examples of the preferred embodiment are illustrated in the accompanying drawings. While the invention will be described in conjunction with the preferred embodiments, it is understood that the invention is not limited to these embodiments. Rather, the invention is intended to cover alternatives, modifications and equivalents, which may be included within the spirit and scope of the invention, as defined by the appended claims. Additionally, in the following detailed description of the present disclosure, numerous specific details are set forth in order to provide a thorough understanding of embodiments of the present invention. However, it will be apparent to one of ordinary skill in the art that the present invention may be practiced without these specific details. In other instances, well-known methods, procedures, components, and operations have not been described in detail so as not to unnecessarily obscure aspects of the present invention.

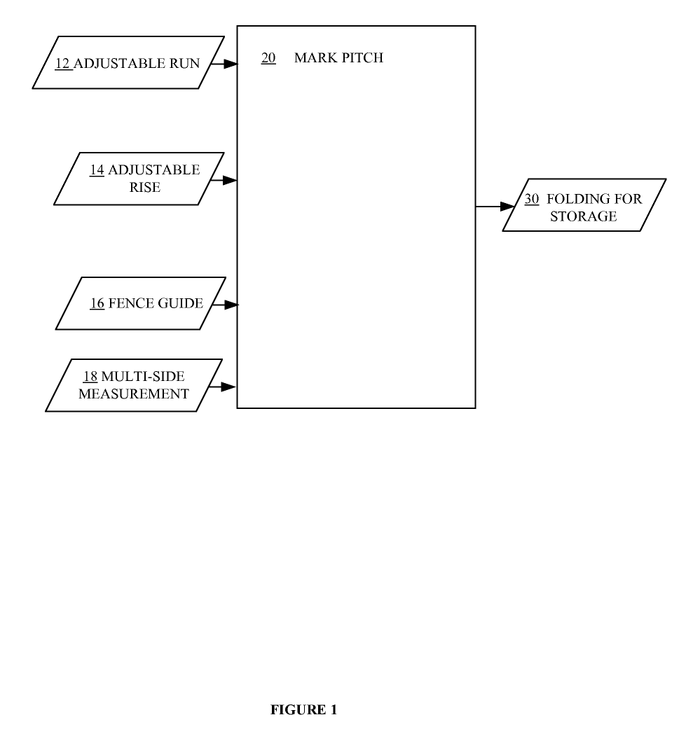

Referring now to FIG. 1, a functional block diagram 100 of a measuring system is shown, according to one or more embodiments. The function of marking a pitch 20 has as inputs, an adjustable run function 12, and/or an adjustable rise function 14, a fence guide function 16, and an optional multi-side measurement function 18, with an output 30 of compact folding for storage and transport. The functions provided herein are enabled in the subsequent apparatus and method descriptions.

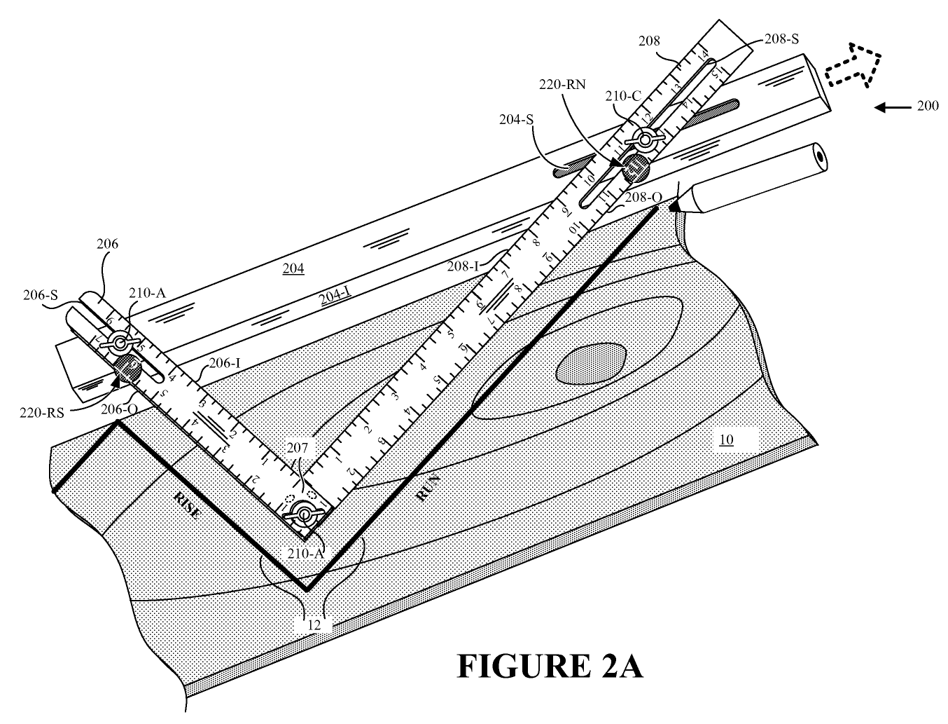

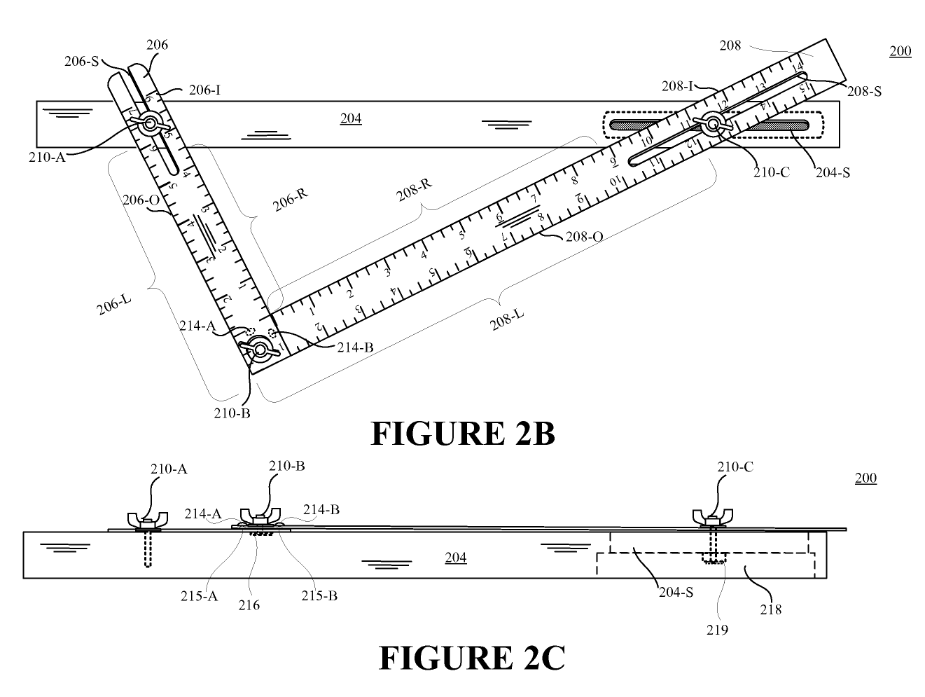

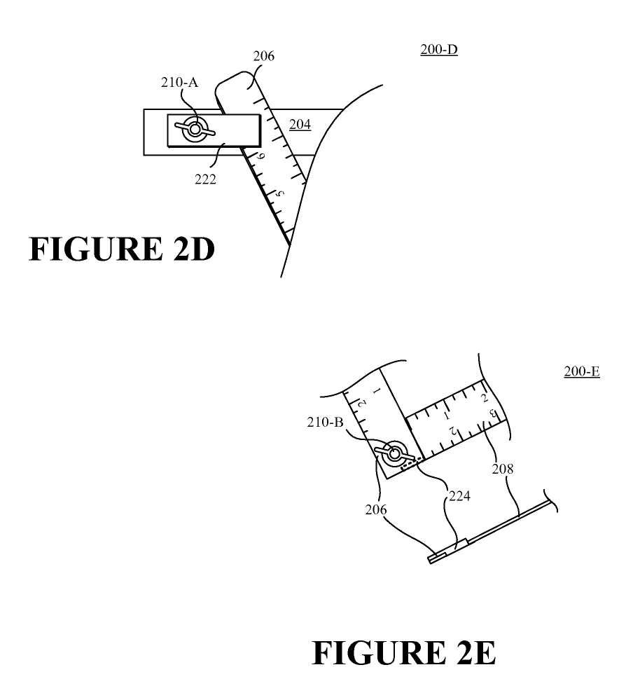

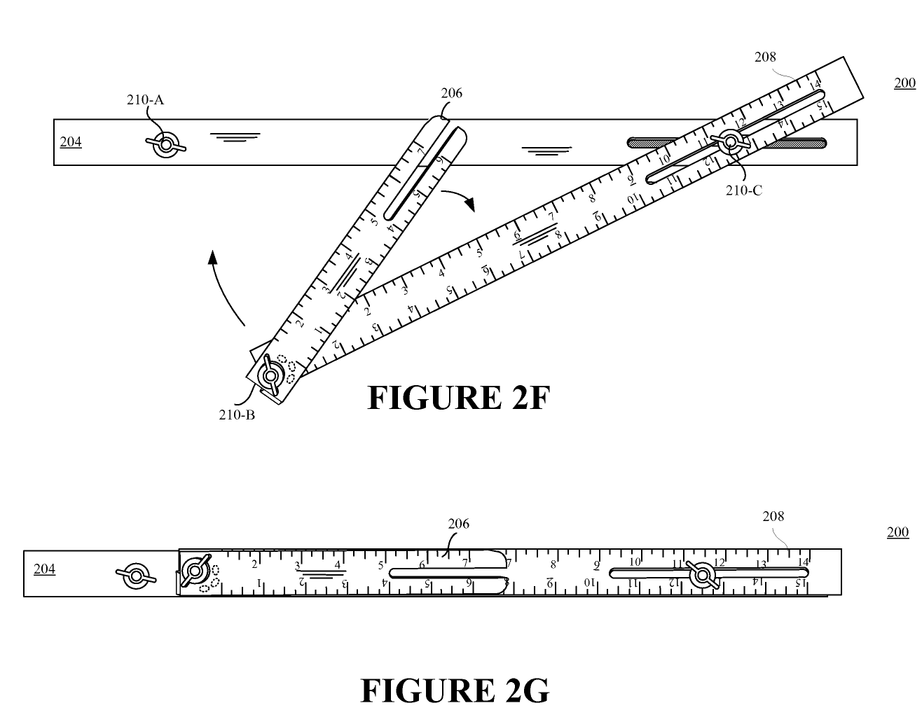

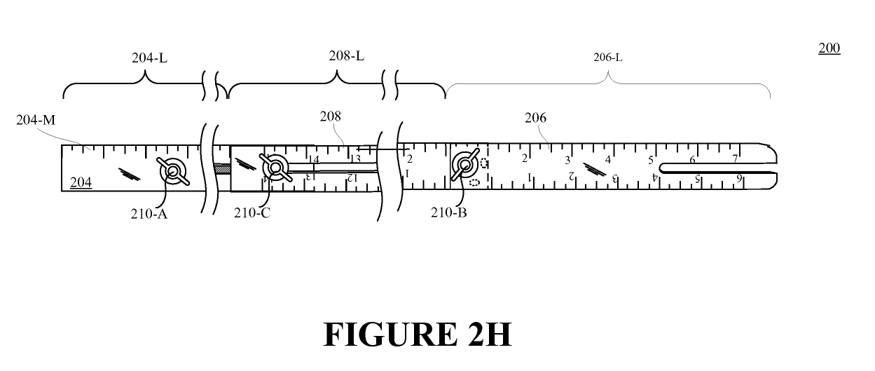

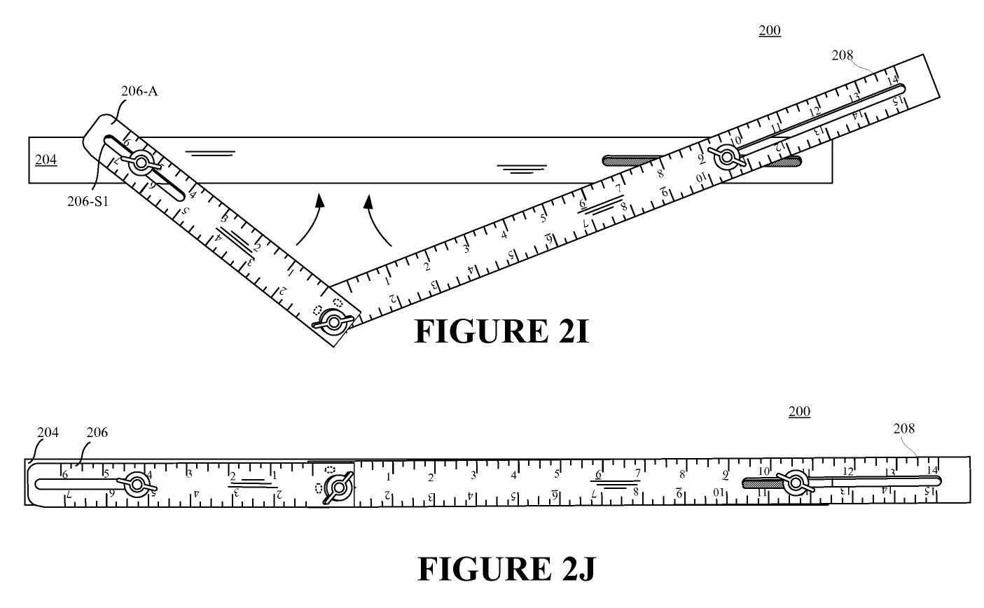

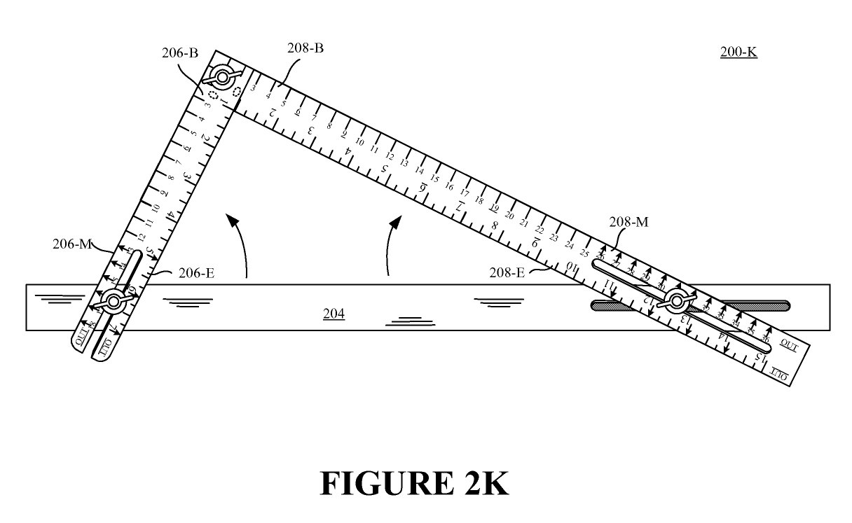

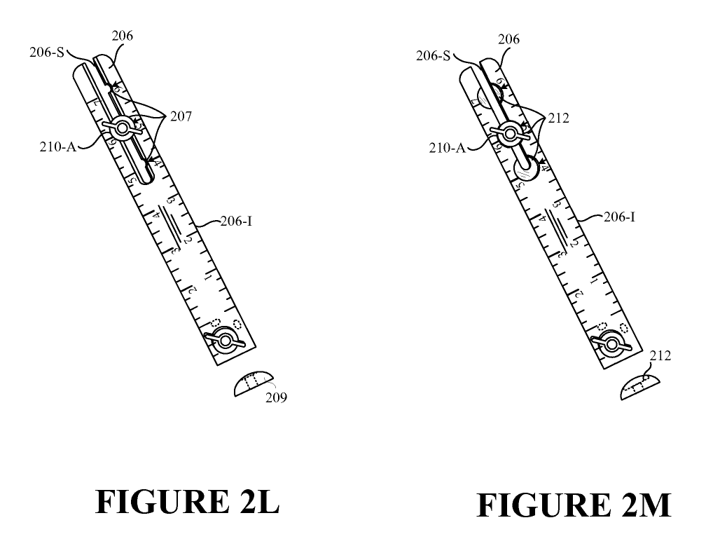

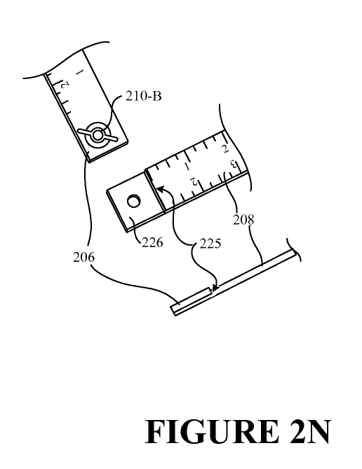

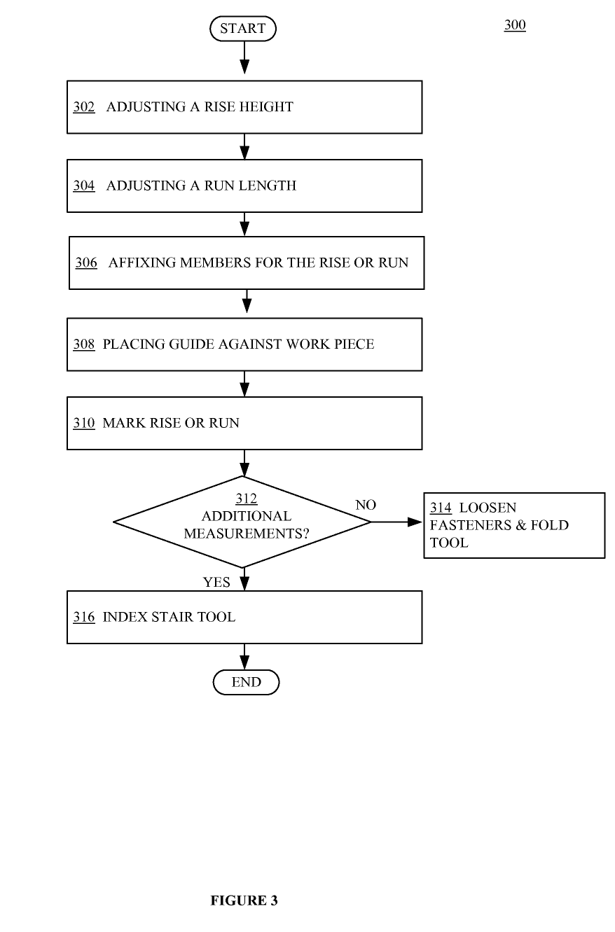

Referring now to FIG. 2A, an isometric view 200 of a tool against a wooden stair stringer 10 in an open position, for measuring or marking a rise and run dimension is shown, according to one or more embodiments. Guide member 204 is coupled to first member 206 for marking a rise dimension of a cut line, and is coupled to second member 208 for marking a run dimension of the cut line. First member 206 is coupled to guide member 204 by wing-nut fastener 210-A, and to second member 208 by fastener 210-B, while second member 208 is coupled to guide member 204 by fastener 210-C, with a resulting rise measurement 220-RS of 6 inches (″), and a resulting run measurement 220-M of 12″. Wing-nut fasteners, or other fasteners such as a thumb screw or quarter-turn fastener, allow for quick and easy tightening and loosening while adjusting members for desired rise and run. When inside face 204-I of tool 200 is placed against work piece 10, then cut line 12 on stringer work piece 10 marks the rise dimension on a first, or outside, edge 206-O of first member 206, and marks the run dimension on a second, or outside, edge 208-O of second member 208. Alternatively, inside edges 206-I and 208-I could be used for marking cut lines or a rafter rake cut line, by measuring from the inside intersection point of the right triangle formed by first and second members 206 and 208, respectively, to the intersection of the first member 206 and second member 208 with the guide member 204, respectively. After marking cut lines for a given set of riser and tread, tool 200 is advanced up the stringer, as shown by dashed arrow.

Lengths for first member 206 and second member 208 and lengths of slots 204-S, 206-S and 208-S can be any value required to provide a desired range of pitches, e.g., rises and runs, with guide member 204 being long enough to couple first 206 and second 208 member together. In one embodiment, a non-exhaustive sample of traditional, or standard, lengths and applications are as follows:

TABLE 1
RISES AND RUNS FOR DIFFERENT APPLICATIONS
APPLICATION

| | |
|---|---|
| STAIR STRINGER | ROOF RAKE |

| RISE | RUN | RISE | RUN |
|---|---|---|---|
| . . . | . . . | . . . | . . . |
| 7 | 11 | 12 | 12 |
| 7 | 12 | 6 | 12 |
| 6 | 12 | 5 | 12 |
| 5 | 12 | 4 | 12 |
| . . . | . . . | . . . | . . . |

Referring now to FIGS. 2B and 2C, a top and side view, respectively, of a tool 200 in an open position for measuring and marking a rise and run dimension is shown, according to one or more embodiments. First member 206 forms a slot 206-S (slot edge) within which fastener 210-A is disposed and is threaded into body of guide member 204. Similarly, guide member 204 forms slot 204-S (slot edge) while second member 208 forms slot 208-S (slot edge), within both fastener 210-C is disposed and coupled to nut 219 with freedom to move in cavity 218 of guide member 204. While cut lines 12 of FIG. 2A utilize outside, or outer, edge 206-O and 208-O to measure a longer rise and run length 206-L and 208-L, respectively, inside, or inner, edges 206-I and 208-I can be used to measure a reduced length of rise 206-R and run 208-R, respectively. Thus, tool 200 has two triangles: an inner triangle formed by edges 206-R, 208-R and the bottom face of guide member 204; and an outer triangle formed by edges 206-I, 208-I, and the top edge of guide member 204. Fastener 210-B that couples first member 206 and second member 208 together has a short threaded shank and a smooth flat head 216 on the backside so as not to interfere with the work piece 10. The square relationship between first member 206 and second member 208 is maintained by detents 214-A and 214-B of first member 206 with fit over mating detents 215-A and 215-B of second member 208.

Members 206 and 208 and guide member 204 are separable parts that can be individually replaced if one gets damaged, thus preserving the majority of the tool and only replacing the one part needed. Likewise, if a different feature for one or both members 206, 208 or guide member 204 is desired, that specific member can be replaced, e.g., for different standard slope settings, as described hereinafter. All ends of members 206, 208 and 204 are selectively affixed to each other, but can be selectively adjusted or lengthened as well because of adjustable fasteners. In one embodiment, intersection formed by member 206 and 208, where fastener 210-B is located, is a solid joint, either by permanent fasteners, or by having member 206 and 208 as a single continuous member. In this latter embodiment, tool 200 would not collapse to as small a footprint as the previous embodiment, but would still provide all the features of adjustability for the rise and run (pitch) measurement and marking, while having a guaranteed and sturdy right angle construction.

Referring now to FIG. 2D, a top view of a portion of tool 200-D with an alternative embodiment retainer for adjustably coupling a first member 206 used for measuring rise, against a guide member 204 of a tool is shown, according to one or more embodiments. In particular, fastener 210-A retains a tab 222 that sandwiches first member 206 against guide body 204 without the need for a slot in first member 206. The present disclosure is well-suited to any method of, and device for, retaining first member 206 to guide member 204 while allowing rotational and translational adjustment of first member 206 to provide different rise lengths.

Referring now to FIG. 2E, a top view of a portion of tool 200-E, with a ninety-degree view thereof, having an alternative embodiment end piece of a first member 206 and second member 208 that create a right triangle intersection for the rise and run dimension, respectively, is shown according to one or more embodiments. In particular, tab 224 of first member 206 is bent to fit into a notch of second member 208 such that the outside edges are flat and a smooth or continuous cut lines can be easily drawn. The present disclosure is well-suited to any method of, and device for, ensuring a 90° right angle formed by first member 206 and second member 208 in order to provide a rise and run that are square, or at a right angle.

Referring now to FIGS. 2F and 2G, top views of a tool 200 changing from a partially-closed to a fully-closed folded position for storage and transport is shown, according to one or more embodiments. To close, or collapse, tool 200, fasteners 210-A, 210-b, and 210-C are loosened sufficiently to allow first member 206 to rotate and fold, or close, on top of member 208, and then to allow member 208 to rotate, or fold, on top of guide member 204, thus presenting a composite shape of tool 200 that is nominally, or approximately, the size of the largest member, the guide member 204. This provides a compact collapsible triangle tool that is less susceptible to damage, and is easier to store and transport.

Referring now to FIG. 2H, a top view of a tool 200 with first member 206, second member 208, and guide member 204 swung into a position that creates a longest overall distance of the assembly, for purposes of providing a linear measuring tool, is shown according to one or more embodiments. Thus the configuration in the present figure provides a long measuring device that provides another feature for tool 200 besides pitch measurements. Fastener 210-A is loosened to allow first member 206 to swing away to opposite end of guide member 204 while still being retained by second member 208. Then, second member 208 is slid down slots 208-S and 204-S and linearly aligned with first member 206 such that it protrudes the maximum distance in line with guide member 204, with resultant lengths of guide member 204-L, first member 206-L, and second member 208-L being linearly additive to produce a long measuring tool. Markings on one side of tool 200, e.g., 206-I and 208-I, and optional marking 204-M for guide member 204, can be configured to be continuous when first, second, and guide members are pulled out to their maximum overall length.

Referring now to FIGS. 2I and 2J, top views of a tool 200 changing from a partially-closed position to a fully elongated and stowed position for storage and transport, is shown according to one or more embodiments. In contrast to FIGS. 2E and 2F, the present embodiment does have a closed slot 206-S1 in alternative first member 206-A. Because of the closed slot 206-S1, first member 206-A is not removed from retention by fastener 210-A, but rather is loosely retained by fasteners 210-A, -B, -C and allowed, along with second member 208, to slide, rotate, and straighten out on top of guide member 204. Fasteners 210-A, 210-B, and 210-C can then be tightened to secure parts of tool 200 for transport.

Referring now to FIG. 2K, a top view of a tool 200-K repositioned to an opposite side of a guide member 204, in order to expose a different edge of a first member 206-B and second member 208-B having a different units of measure than the opposing edge 206-M and 208-M, respectively, according to one or more embodiments. With first member 206 and second member 208-B being projected on the top side of guide member 204 in the present illustration, as opposed to the bottom side of guide member 204 as shown in FIGS. 2B and 2C, edges 206-M and 208-M with metric unit measurements in centimeters are now exposed as the outside edges against which a line or measurement will be made on a work piece.

Referring now to FIG. 2L, a top view of a first member 206 portion of the tool, with detents 207 in the slot edge 206-S to provide positioning for traditional rise and run measurements is shown, according to one or more embodiments. In particular, shaft of fastener 210-A can be positioned by user into one of detents 207 that would correspond to traditional or standard measurements. The same detent system can be utilized for member 208. The dimensional markings on members 206, 208 can be modified to compensate for any minor offset arising from the depth of detent 207 affecting the position of members 206, 208 against body 204, to ensure that rise over run measurements are accurate, e.g., where a desired 12″ run actually draws out on the cut line as a 12″ run. Without detents, alignment of the first member 206 and second member 208 can be tedious because of the small unit measurement markings, dirt and debris partially blocking unit measurements, and slippage caused by adjusting the opposite member, e.g., first member 206 might slip while adjusting position of second member 208. In one embodiment, shape of first member 206 is rounded on the top surface 209 having unit markings, especially in the range of slot 206-S, to provide for easier reading of measurements from a distance or from an angle to a work piece. Second member 208 can have a similar rounded shape on a top surface with unit markings, especially in the range of the slot 208-S where measurements will be taken. Having a rounded or peak-shaped cross-section of first member 206 and/or second member 208 will not impede in the closing and stowage of tool 200 if first and second members 206, 208, are not folded on top of each other but rather laid out lengthwise as illustrated in FIGS. 2I and 2J. Ends of first member 206 and second member 208 that intersect at fastener 210-B can be flat and planer as illustrated in previous figures. Fasteners 210-A and 210-C are longer to accommodate an increased height of members 206 and 208, though a rounded or peak top surface may have flats thereon to accommodate positions where fasteners 210-A and 210-C will clamp down.

In an alternative embodiment shown in FIG. 2M, a top view of a first member 206 portion of the tool, with square or tapered countersinks, or recessed faces 212, on member 206 is shown, in accordance with one or more embodiments. Recessed faces 212 are located at standardized run measurements of 4, 5, and 6 inches, and have a diameter nominally sized to allow flange, or skirt, of fastener 210-A to fit therein and be trapped from moving, thereby maintaining the desired run measurement. Any type of retainment is useful in the present disclosure to keep member 206 positioned at a given rise measurement, while optionally allowing some rotational, or pivoting, capability of member 206 to accommodate variable run settings on member 208 to be set, which might require some rotation of member 206 about centerline of fastener 210-A. For both FIGS. 2L and 2M, fastener 210-A can be positioned into one of a plurality traditional or standard measurements, e.g., in one of the plurality of detents 207 or plurality of countersunk positions 212 that corresponds to one of the rise measurements provided in Table 1. While only three settings are illustrated in the exemplary figure, the present disclosure is well-suited to a wide range of rise settings, and to applying this same design to the second member 208 to provide a plurality of possible standard or traditional run settings. The resulting combination of pitch selections, or settings, can have any combination of Y rise values by X run values, making a total of the product of Y and X (Y*X) combinations of standard selectable dimensions of rise and run values, on a first edge and a second edge, respectively, using the present tool 200. Unlike a solid non-adjustable measuring device, e.g., a carpenter's square, the present disclosure actually adjusts the size of the tool 200 such that drawing a line around the first and second member creates a single cutout line for a single pitch when the tool is placed on a work piece. Assuming a tool 200 has a choice of two possible preset standard run length settings, e.g., 11″ and 12″, and a choice of 3 standard rise length settings, e.g., 5″, 7″, and 12″, then there are six (6) possible preset pitch settings that are easy to select, (11×5, 11×7, 11×12, and 12×5, 12×7, and 12×12), and are easy to use for drawing a cut line. By selectively altering the shape and size of tool 200 for rise and run, then locking it into position by tightening fasteners 210-A, -B, -C, a consistent rise and run cut line pattern can be repeatedly marked, e.g., sequentially along a stair stringer, without having to manually inspect the dimension on the rise and run. Alternatively, one rise and two run length choices yield two (2) possible preset pitch combinations, while two rise and two run length choices yield four (4) possible present pitch combinations. Other combinations of preset rise and run could yield combinations of 5, 6, 8, 10 or as many settings as desired or practical. In addition to the present rise and runs, the present invention is still well-suited to any pitch or rise/run combination desired, e.g., an infinitely variable number of positions or pitches, by avoiding the detents 207 or countersinks 212 and positioning the first member 206 and second member 208 at the desired value for rise and run, and securing same to guide member 204 and each other via fasteners 210-A, -B, -C. Thus, while presets are very convenient for standard pitch settings like rafter cutouts, non-standard pitches are typically used for stair cutouts, as the pitch depends on non-standard distances between landings on floors, a value dependent upon many variable factors such as subfloor heights and building variations. All parts of tool 200 are integrated and fastened together to prevent loss of individual parts. Nylon insert lock nuts, or threaded inserts, can be used in tool 200 for fasteners 210-A, -B, -C to prevent accidental loosening.

Referring now to FIG. 2N, a top exploded view of an alternative end piece of a first member and second member of a tool that creates a right triangle intersection for the rise and run dimension, respectively, is shown according to one or more embodiments. In particular, a flat 226 is milled, or formed, on second member 208 to create a lip, or edge, 225 against which first member 206 will be locked into a right angle to ensure a square outline for tool 200, and subsequently a square cut line drawn on a work piece. By sufficiently loosening fastener 210-B, first member 206 can be raised sufficiently to clear edge 225, and allow tool 200 to fold closed as previously described.

Referring now to FIG. 3, a flowchart of a method 300 for measuring or marking a rise or run on a work piece using a tool is shown, according to one or more embodiments. In operation 302, a rise height is adjusted or set for first member 206, e.g., of FIG. 2A-2C, according to a desired rise measurement, e.g., from Table 1. Building codes and actual housing structure will be considered in this step as known by those skilled in the construction trade. Operation 304 similarly adjusts a run length of second member 208, e.g., of FIG. 2A-2C. In operation 306, members are affixed to lock in the desired rise and run, e.g., fasteners 210-A, 210-B, and 210-C are screwed down to lock in first member 206 and second member 208 against each other and against guide member 204 to provide a consistent rise and run when marked repeatedly, e.g., for each of the multiple stairs on a stringer, or for each of multiple rafters for a roof. The tool is placed against a work piece for marking the rise or run in operation 308 with the marking occurring in operation 310, using either inside edges 206-I, 208-I or outside edges 206-O, 208-O, of first and second members 206, 208, respectively. Operation 312 inquires whether additional measurements are to be taken, e.g., for marking additional cuts for stairs on a stringer. If yes, the tool is indexed per operation 316, and as shown in FIG. 2A, by slidably moving guide member 204, e.g., acting as a fence, along work piece 10 such that a new rise will continue from the past run, thereby creating successive and contiguous cut line markings along work piece 10, e.g., for a stair stringer. If no additional measurements are needed, then fasteners, e.g., 210-A, 210-B, and 210-C, can be loosened allowing first member 206 and second member 208 to be rotated and stowed. Fasteners 210-A, 210-B, and 210-C can then be retightened to secure the parts of the tool

First member 206, second member 208, and guide member 204 are substantially flat, planar, right angle, and rigid pieces, in one embodiment, made of any suitable material for measuring and marking equipment, such as plastic, metal, etc. that provide robustness as well as durability and dimensional stability in a variety of working temperatures and environments. Any member may be made of opaque or translucent material. Alternatively, any member may be made of transparent material throughout or simply at edges to allow visibility of marking indicia when measuring or marking on a work piece.

The present description is applicable to a wide variety of applications and is not limited to any particular type of materials, measurement markings, hinge or pivot type, sizes or geometries of surfaces other than the a straightedge of members 206, 208, and 204. Rather, the present description is applicable to a wide variety of materials, measurement markings, geometries, hinges and pivot types and arrangements that meet the marking functions listed herein.

Methods and operations described herein can be in different sequences than the exemplary ones described herein, e.g., in a different order. Thus, one or more additional new operations may be inserted within the existing operations or one or more operations may be abbreviated or eliminated, according to a given application, so long as substantially the same function, way and result is obtained.

Although the present embodiments have been described with reference to specific example embodiments, it will be evident that various modifications and changes may be made to these embodiments without departing from the broader spirit and scope of the various embodiments.

The foregoing descriptions of specific embodiments of the present disclosure have been presented for purposes of illustration and description. They are not intended to be exhaustive or to limit the invention to the precise forms disclosed. Many modifications and variations are possible in light of the above teaching without departing from the broader spirit and scope of the various embodiments. The embodiments were chosen and described in order to explain the principles and practical application of the invention and to enable others skilled in the art to better utilize the invention. It is intended that the scope of the invention be defined by the Claims appended hereto and their equivalents.

What is claimed is:

1. A tool comprising:
a first member having a straightedge for marking a rise dimension;
a second member having a straightedge for marking a run dimension, wherein the first member and the second member are coupled to each other to form a right angle with respect to each other; and
a third member, having a straightedge, that is adjustably coupled to the first member and the second member, wherein the third member acts as a fence against a work piece and wherein the first member and the second member indicate a pitch on the work piece.

2. The tool of claim 1 wherein a length of the first member extending from the third member is selectively adjustable to provide variable rise dimension.

3. The tool of claim 1 wherein a length of the second member extending from the third member is selectively adjustable to provide a variable run dimension.

4. The tool of claim 1 wherein a length of the first member and a length of the second member are simultaneously adjustable to provide a variable pitch having a variable rise and a variable run.

5. The tool of claim 1 wherein the first member and the second member each have a first end with a slot formed therein to adjust a length of the first member and a length of the second member with respect to the third member to thereby provide a variable rise dimension of the first member and a variable run dimension of the second member.

6. The tool of claim 1 wherein:
the first member locks into a position with respect to the third member to maintain a fixed rise dimension while the second member has a length that is adjustable with respect to the third member to create a variable run length.

7. The tool of claim 1 wherein the second member locks into a position with respect to the third member to maintain a fixed run dimension while the first member has a length that is adjustable with respect to the third member to create a variable rise length.

8. The tool of claim 1 wherein:
the first member has a first quantity of selectable preset dimensions for a rise setting;
the second member has a length for a run dimension; and
wherein the tool has a plurality of preset pitch combinations from which to select that is equal to the first quantity.

9. The tool of claim 8 wherein:
the second member has a second quantity of selectable preset dimensions for a run setting; and
the tool has a plurality of preset pitch combinations from which to select that is equal to the first quantity times the second quantity.

10. The tool of claim 1 further comprising;
retaining means for locking the first member against the third member for a fixed rise dimension; and
retaining means for locking the second member against the third member for a fixed run dimension.

11. The tool of claim 1 wherein the first member, the second member, and the third member fold on top of each other to form a composite shape approximately a size of the third member.

12. The tool of claim 1 wherein the first member, the second member, and the third member are individually disassemblable from each other.

13. The tool of claim 1 further comprising:
a stop formed in one end of the first member or the second member to ensure the first member and the second member form a right angle with respect to each other.

14. The tool of claim 1 wherein the first member, the second member, and the third member form a triangle shape.

15. The tool of claim 1 wherein:
the first member, the second member, and the third member form a plurality of triangles;
an outer triangle is formed by an outer straightedge of the first member and an outer edge of the second member and an outer edge of the third member; and
an inner triangle is formed by an inner straightedge of the first member and an inner straightedge of the second member and an inner straightedge of the third member.

16. The tool of claim 1 wherein the first member is linearly alignable with the second member and with the third member to create a continuous linear scale.

17. The tool of claim 1 wherein:
a length of the first member extending from the third member is infinitely variable to provide an infinitely variable rise dimension; and
a length of the second member extending from the third member is infinitely variable to provide an infinitely variable rise dimension.

18. A tool comprising:
a first member having a straightedge with a graduated scale for marking a rise dimension;
a second member having a straightedge with a graduated scale for marking a run dimension, wherein the first member and the second member are coupled to each other to form a right angle with respect to each other; and
a third member, having a straightedge, that is adjustably coupled to the first member and the second member, wherein the third member acts as a fence against a work piece and wherein the first member and the second member indicate a pitch on a work piece;
wherein a length of the first member extending from the third member is selectively adjustable to provide a variable rise dimension; and
wherein a length of the second member extending from the third member is selectively adjustable to provide a variable run dimension.

19. The tool of claim 18 wherein:
the first member has a first quantity of selectable preset dimensions for a preset rise setting;
the second member has a second quantity of selectable preset dimensions for a preset run setting; and
wherein the tool has a plurality of preset pitch combinations from which to select that is equal to the first quantity times the second quantity.

20. The tool of claim 18 wherein the first member, the second member, and the third member fold on top of each other to form a composite shape approximately a size of the third member.
